(19) United States
(12) Patent Application Publication
(10) Pub. No.: US 2009/0228678 A1
(43) Pub. Date: Sep. 10, 2009

(54) MAPPING DEFINITION CREATION SYSTEM AND MAPPING DEFINITION CREATION PROGRAM

(76) Inventors: Hideki TAKANO, Kawasaki (JP); Ryoichi UEDA, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/365,278

(22) Filed: Feb. 4, 2009

(30) Foreign Application Priority Data
Mar. 6, 2008 (JP) 2008-055998

(51) Int. Cl. G06F 12/06

(52) U.S. Cl. 711/202; 711/E12.078

(57) ABSTRACT

A mapping definition system for creating a mapping definition between a structured data definition of a conversion source and a structured data definition of a conversion target comprises: mapping information extraction means for extracting mapping information from an existing mapping definition and storing the same in a mapping information storage table; and mapping information application means acquiring mapping information necessary for conversion from the mapping information storage table and mapping information stored in the mapping information storage table for creating a mapping definition for the structured data definition of the conversion source and the structured data definition of the conversion target by using the acquired mapping information.

### CROSS-REFERENCE TO RELATED APPLICATION

The present application claims priority from Japanese Patent Application No. JP 2008-055998 filed on Mar. 6, 2008, the content of which is hereby incorporated by reference into this application.

### TECHNICAL FIELD OF THE INVENTION

The present invention relates to a technique of creating a mapping definition to be used in data conversion from a specific format to another format by a program operating on a computer. In particular, the present invention relates to a technique effectively applied to creation of a mapping definition to be used when converting structured data such as XML (Extensible Markup Language).

### BACKGROUND OF THE INVENTION

In recent years, as represented by EAI (Enterprise Application Integration) and SOA (Service Oriented Architecture), there have been demands for improvements in usability of the whole system of a business information system by linking softwares called as existing applications and services scattered within the business information system. Further, in the construction of the system by such a method, there have been demands for making it possible to perform a flexible system change by replacing a specific software only to be changed at the time of the system change that might arise from the change and so forth of the company business.

At this time, since there are differences between formats of the structured data handled by respective softwares of to be linked, it is indispensable not only to replace the software, but also to perform a data conversion in order to allow the structured data being specific to the software to be conformed to a mountable format of the system. This data conversion is executed based on this mapping definition by creating a mapping definition describing conversion regulations which are the ways of conversion in advance. Hence, a user is required to create the mapping definition by performing association between elements owned by the respective structured data in advance.

Here, Japanese Patent Application Laid-Open Publication No. 2002-99561 (Patent Document 1) discloses a technique for making it possible to automatically perform mapping by searching and finding an element name corresponding to an element name of structured data of a conversion source from structured data of a conversion target by using a thesaurus.

Further, Japanese Patent Application Laid-Open Publication No. 2006-277660 (Patent Document 2) discloses a technique in which a definition part of a function (function used for conversion) used for a conversion of element name parts or elements of a conversion source or a conversion target of structured data contained in an existing mapping definition is abstracted to be made as a variable, and when the variable is actually applied to schema of the conversion source and the conversion target, the variable is allotted with a specific element name and function, so that the existing mapping definition can be reused.

### SUMMARY OF THE INVENTION

In the technique disclosed in Patent Document 1, while it is possible to automatically perform mapping between corresponding elements by using a thesaurus, it is necessary to prepare the thesaurus in advance. In addition, since it is often the case that the element name of the structured data is created by combining a plurality of words, it is not easy to prepare an effective thesaurus. Further, since it is only known whether or not the word is the same from a thesaurus, the mapping automatically performable is limited to a simple one. That is, it is not possible to automate complicated mappings such as those containing functions.

On the other hand, in the technique disclosed in the Patent Document 2, since the mapping definition having been already manually created is reused, it is possible to automatically perform mapping even if it is a complicated mapping. However, in this method, it is necessary to manually process a mapping so that the mapping definition once created can be reused, and this increases an operational load. Further, since the number of mapping definitions simultaneously usable for a pair of structured data definitions is only one, when no mapping definition whose structure conforms to the structure of the structured data definition is available in the existing mapping definitions, it is necessary to create a new mapping definition.

Accordingly, an object of the present invention is to provide means for making it possible to automatically perform mapping without having a need for the preparation of the thesaurus and the processing of the mapping definition in advance even when no mapping definition whose structure conforms to the structure of the structured data definition is available in the existing mapping definitions. The above and other objects and novel characteristics of the present invention will be apparent from the description of the present specification and the accompanying drawings.

The typical ones of the inventions disclosed in the present application will be briefly described as follows.

A mapping definition creation system according to a typical embodiment of the present invention includes: a mapping information storage table for storing mapping information extracted from an existing mapping definition; mapping information extraction means for extracting the mapping information from the existing mapping definition and stores it in the mapping information storage table; and mapping information application means for acquiring the mapping information necessary for converting an element of a structured data definition of conversion source into a corresponding element of a structured data definition of conversion target from the mapping information stored in the mapping information storage table for each element of the structured data definition of conversion source and the structured data definition of conversion target to be converted, and creating a mapping definition by using the acquired mapping information.

The effects obtained by typical aspects of the present invention will be briefly described below.

According to a typical embodiment of the present invention, by combining existing mapping definitions and automatically performing an inverse conversion of the existing mapping definitions, mapping can be automatically performed even when no mapping definition whose structure conforms to the structure of a structured data definition is available in the existing mapping definitions. Further, according to a typical embodiment of the present invention, since there is no need for preparing a thesaurus and processing a mapping definition in advance, operational load on a user of an advance preparation can be reduced.

### BRIEF DESCRIPTIONS OF THE DRAWINGS

FIG. 1 is a diagram illustrating a configuration example of a mapping definition creation system of a first embodiment of the present invention;

FIG. 2 is a diagram illustrating an example of a screen configuration of a mapping definition editor according to the first embodiment of the present invention;

FIG. 3 is an example of a flowchart of a mapping information extraction processing according to the first embodiment of the present invention;

FIG. 4A is a diagram illustrating an example of an existing mapping definition according to the first embodiment of the present invention;

FIG. 4B is a diagram illustrating an example of an existing mapping definition according to the first embodiment of the present invention;

FIG. 5 is a diagram illustrating examples of data configuration and data of a mapping information storage table according to the first embodiment of the present invention;

FIG. 6 is an example of a flowchart of a mapping information application processing according to the first embodiment of the present invention;

FIG. 7 is an example of a flowchart of an acquisition processing of a candidate list of paths by mapping information according to the first embodiment of the present invention;

FIG. 8 is an example of a flowchart of a processing for searching for a path reaching an element of a structured data definition of conversion source from an element of a structured data definition of conversion target according to the first embodiment of the present invention;

FIG. 9 is a diagram illustrating examples of a structured data definition of conversion source and a structured data definition of conversion target according to the first embodiment of the present invention;

FIG. 10 is an example of a flowchart of a processing for applying the mapping information to the mapping definition editor according to the first embodiment of the present invention;

FIG. 11 is a diagram representing examples of a data structure and data of an inverse function management table according to the first embodiment of the present invention;

FIG. 12 is a diagram illustrating examples of a mapping definition according to the first embodiment of the present invention; and

FIG. 13 is an example of a flowchart of an automatic mapping processing for a specific element according to a second embodiment of the present invention.

### DESCRIPTIONS OF THE PREFERRED EMBODIMENTS

Hereinafter, embodiments of the present invention will be described in detail with reference to the accompanying drawings. Note that, components having the same function are denoted by the same reference symbols throughout the drawings for describing the embodiment, and the repetitive description thereof will be omitted.

### First Embodiment

A mapping definition creation system which is a first embodiment of the present invention is a system in which pieces of mapping information (a set of an element (node or function) of conversion source and an element of conversion target (a pair of mappings)) extracted from mapping definitions previously created by a user are combined and reused, so that mapping is automatically performed for a targeted structured data definition, thereby creating a new mapping definition. Specific contents thereof will be described hereinafter.

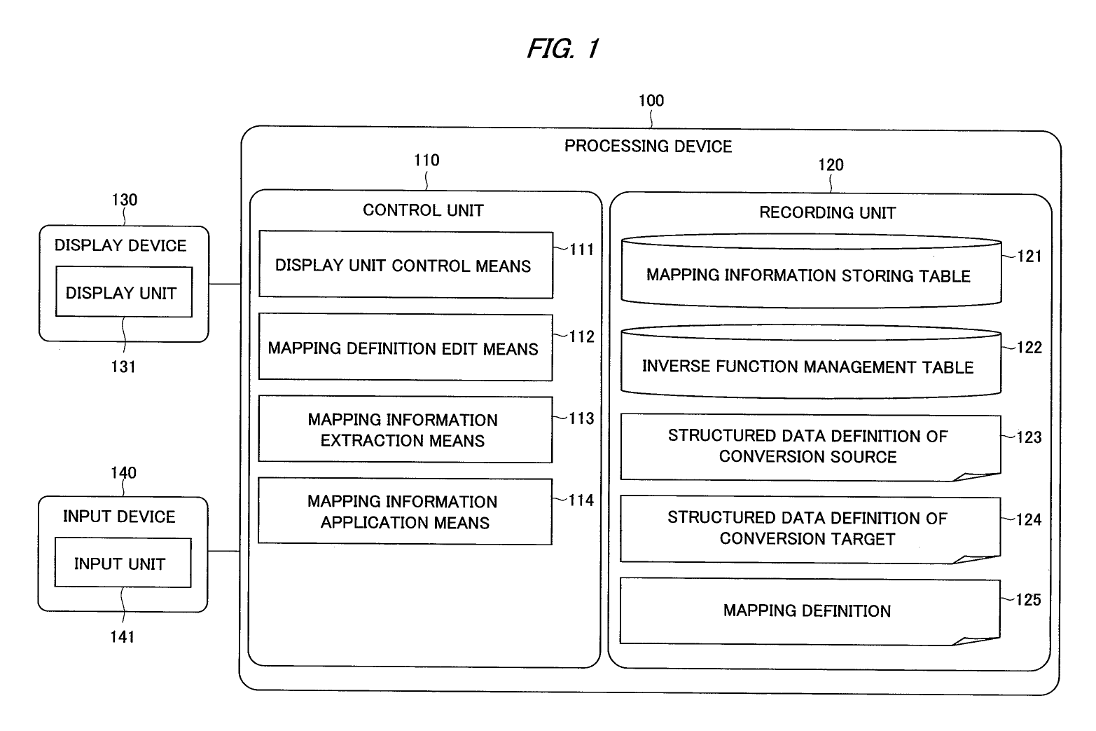

FIG. 1 is a diagram illustrating a configuration example of the mapping definition creation system of the present embodiment. The mapping definition creation system is configured by a processing device 100, a display device 130, and an input device 140. The processing device 100 is mounted by a computer system having a storage device such as an HDD, a memory, and a CPU, and is configured by a control unit 110 and a memory unit 120.

The control unit 110 includes display unit control means ill, mapping definition edit means 112, mapping information extraction means 113, and mapping information application means 114. Each of these means is mounted by one or a plurality of programs, and is stored in the storage device owned by the processing device 100. These programs are read from the storage device into the memory to be executed by the CPU, so that the operation of each of these means is realized.

The display unit control means 111 is means for controlling a display unit 131 of the display device 130 to be described later. The mapping definition edit means 112 displays structured data definitions of a conversion target and mapping definitions about the structured data definitions to the display unit 131 by the display unit control means 111, and is means for providing a user interface for creating and editing the mapping definitions by a dialogue with the user using the display unit control means 111.

The mapping information extraction means 113 is means for extracting mapping information from existing mapping definitions created by the mapping definition edit means 112 and storing the mapping information in a mapping information storage table 121 to be described later.

The mapping information application means 114 is means for acquiring mapping information necessary for converting each element of the structured data definitions to be converted from the mapping information stored in the mapping information storage table 121, and creating a mapping definition for the structured data definition to be converted by using the acquired mapping information to apply the created mapping information on a mapping definition editor to be described later.

The memory unit 120 is mounted by the storage device owned by the processing device 100, and holds the mapping information storage table 121, an inverse function management table 122, a structured data definition of conversion source 123, a structured data definition of conversion target 124, and a mapping definition 125 in a format of a database and a file. In the present embodiment, although not limited to these, the mapping information storage table 121 and the inverse function management table 122 are made into a format of database in consideration of easiness of retrieval, while the structured data definition of conversion source 123, the structured data definition of conversion target 124, and the mapping definition 125 are made into a format of file.

In the XML, it is often the case that an XML schema and a DTD (Document Type Definition) are used as the structured data definition, and an XSL (Extensible Stylesheet Language) is used as the mapping definition.

The mapping information storage table 121 is a table for storing the mapping information extracted from the existing mapping definitions. Further, the inverse function management table 122 is a table for storing functions and its inverse functions to be used at the time of mapping and conditions at the time of applying the inverse functions. The inverse function will be described later.

The display device 130 includes the display unit 131, and displays processing results of the processing device 100 for the user, and displays the mapping definition editor to be described later which is a user interface provided by the mapping definition edit means 112. The display device 130 is, for example, configured by a display such as a liquid crystal display and a CRT. In the present embodiment, the display device 130 displays the mapping definition editor to be described later.

The input device 140 includes the input unit 141, and receives operations and inputs to the processing device 100 by the user, and also receives operations and inputs by the user to the mapping definition editor to be described later. The input device 140 is, for example, configured by a pointing device such as a keyboard and a mouse.

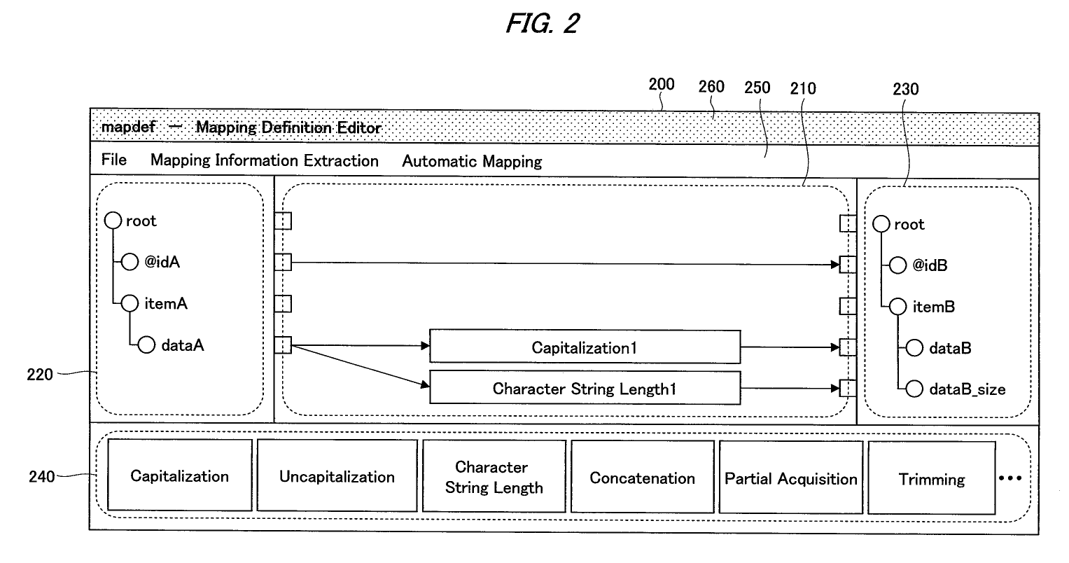

Next, the mapping definition editor will be described. The mapping definition editor is realized by the mapping definition edit means 112. The user can perform the creation and edit of the mapping definition by using the mapping definition editor displayed in the display unit 131 by the display unit control means 111. FIG. 2 is a diagram illustrating an example of a screen configuration of a mapping definition editor 200.

A title bar 260 displays a name (“mapdef” in FIG. 2) of the mapping definition and a name (“Mapping Definition Editor”) of the application during the editing. The left side of the screen displays a tree display area for structured data definition of conversion source 220, and the right side of the screen displays a tree display area for structured data definition of conversion target 230, and displayed between the areas is a mapping display area 210. The bottom of the screen displays a function pallet area 240. A menu 250 receives a command such as a file operation.

The user performs mapping by continuously clicking the elements of the structured data definition of conversion source 123 displayed in the tree display area for structured data definition of conversion source 220 and the elements of the structured data definition of conversion target 124 displayed in the tree display area for structured data definition of conversion target 230 by the mouse, and drawing a mapping line between the elements by operations such as drag and drop. When functions are desired to be used at the time of mapping, the required functions are arranged in the mapping display area 210 from a function pallet area 240 by an operation such as drag and drop, and the mapping line is stretched across the arranged functions, thereby performing mapping.

In the example of the mapping definition shown in FIG. 2, a value of an element “@idA” of the structured data definition of conversion source 123 is stored in an element “@idB” of the structured data definition of conversion target 124, and all values of “dataA” of the structured data definition of conversion source 123 is capitalized and stored in “dataB” of the structured data definition of conversion target 124. A length of a character string of the value of “dataA” of the structured data definition of conversion source 123 is stored in “dataB_size” of the structured data definition of conversion target 124, so that the mapping definition for creating the structured data definition of conversion target 124 from the structured data definition of conversion source 123 is provided. The created mapping definition is stored in the memory unit 120 of the processing device 100 as a mapping definition 125 according to instructions from an operation of the menu 250.

Next, the mapping information extraction means 113 will be described. The mapping information extraction means 113 extracts the mapping information from the mapping definitions created on the mapping definition editor 200 by the user, and stores the same in the mapping information storage table 121. Here, the “mapping information” means a set of an element (node or function) of the conversion source and an element (node or function) of the conversion target. For example, when a function “F” is used for the mapping from a conversion source node “S” to a conversion target node “T”, a total of two pieces of the mapping information such as one piece of mapping information between S and F and one piece of mapping information between F and T are extracted.

The extraction of the mapping information is, for example, executed by selecting the [Mapping Information Extraction] from the menu 250 of the mapping definition editor 200. The extraction of the mapping information may be directly executed to the mapping definition 125 stored in the memory unit 120 without going through the mapping definition editor 200.

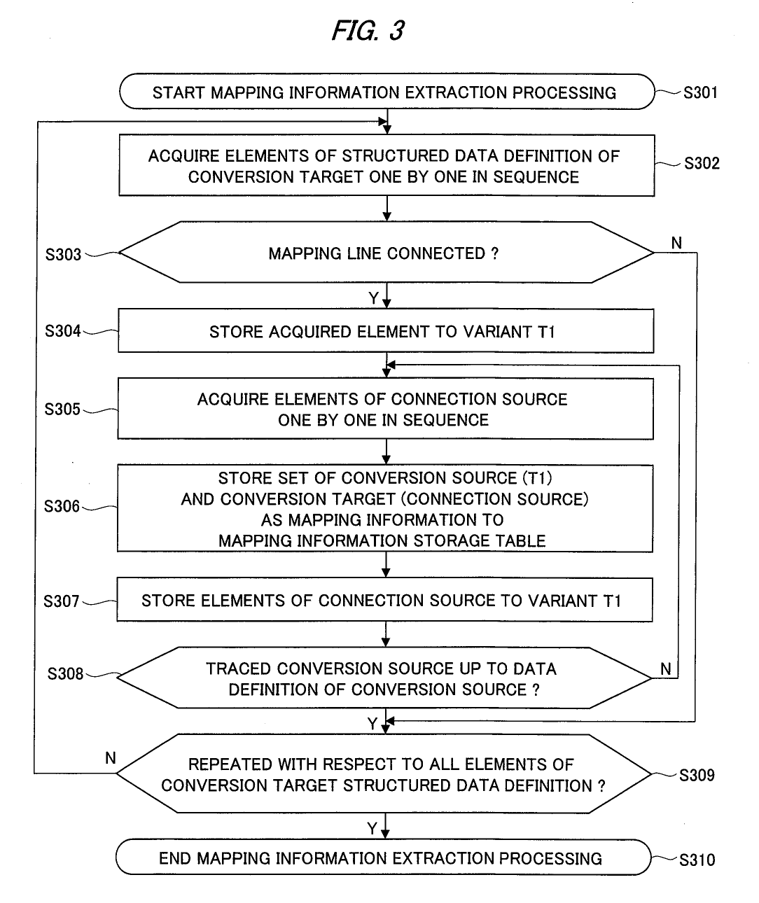

FIG. 3 is an example of a flowchart of a mapping information extraction processing in the mapping information extraction means 113. When the processing is started (S301), the elements of the structured data definition of conversion target are acquired in order one by one (S302). Next, whether or not the mapping line is connected to the acquired element is checked (S303), and when the mapping line is not connected, the processing advances to a step (S309) for checking whether or not the processing has been repeated for all the elements of the structured data definition of conversion target.

When the mapping line is connected to the acquired element, the acquired element is stored in a variable T1 (S304), and the elements of the connection source of the mapping line is acquired in order one by one (S305). When a function receiving a plurality of inputs exists, the elements are acquired in order one by one also for each connection source serving as an input. In this case, the function having the plurality of inputs is substituted for the variable T1.

Next, a set of the elements of the conversion target (T1) and the conversion source (connection source) is stored in the mapping information storage table 121 as the mapping information (S306). At this time, when the element of the conversion source or the conversion target is not a function, but a node, its parent path is also stored together. The “parent path” means a path acquired by tracing the element of the structured data definition in a root direction. For example, the parent path of the element “dataA” of the structured data definition of conversion source 123 shown in FIG. 2 is “/root/itemA”. When the element of the conversion source or the conversion target is a function, a name of the mapping definition is also stored together.

Next, the element of the connection source is stored in the variable T1 (S307), and whether or not the connection source is all traced up to the structured data definition of conversion source 123 is checked(S308). When all the connection source is not traced, the processing returns to the step S305, and the processing is repeated for an element of the next connection source. When the connection source is all traced up to the structured data definition of conversion source 123, whether or not the processing is repeated for all elements of the structured data definition of conversion target 124 is checked (S309). When processing is not repeated for all elements, the processing returns to the step S302, and the processing is repeated for the elements of the next structured data definition of conversion target 124. When the processing is repeated for all elements of the structured data definition of conversion target 124, the processing is terminated (S310).

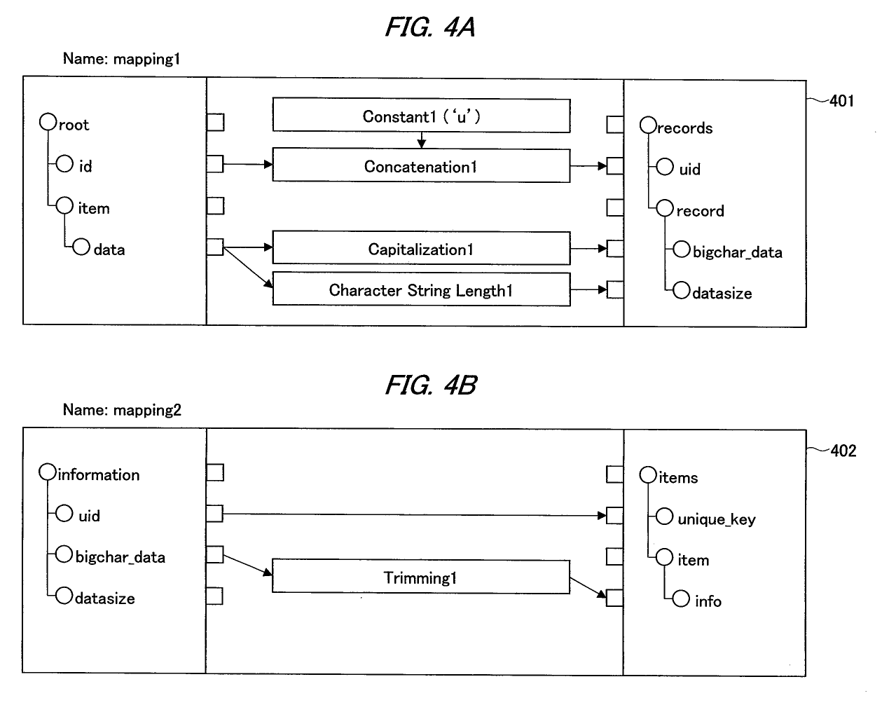

FIGS. 4A and 4B are diagrams illustrating an example of existing mapping definitions. A mapping definition 401 (“mapping1”) concatenates a value of an element “id” of the structured data definition of conversion source 123 to a character ‘U’ and stores the same in an element “uid” of the structured data definition of conversion target 124, and makes all values of an element “data” of the structured data definition of conversion source 123 into upper case (capitalization) and stores the same in an element “bigchar_data” of the structured data definition of conversion target 124, and stores a length of a character string of the value of the element “data” of the structured data definition of conversion source 123 in an element “datasize” of the structured data definition of conversion target 124.

Further, a mapping definition 402 (“mapping2”) stores a value of the element “uid” of the structured data definition of conversion source 123 in an element “unique_key” of the structured data definition of conversion target 124, and a prescribed character string such as a space is deleted (trimmed) from a value of the element “bigchar_data” of the structured data definition of conversion source 123, and the trimmed “bigchar_data” is stored in an element “info” of the structured data definition of conversion target 124.

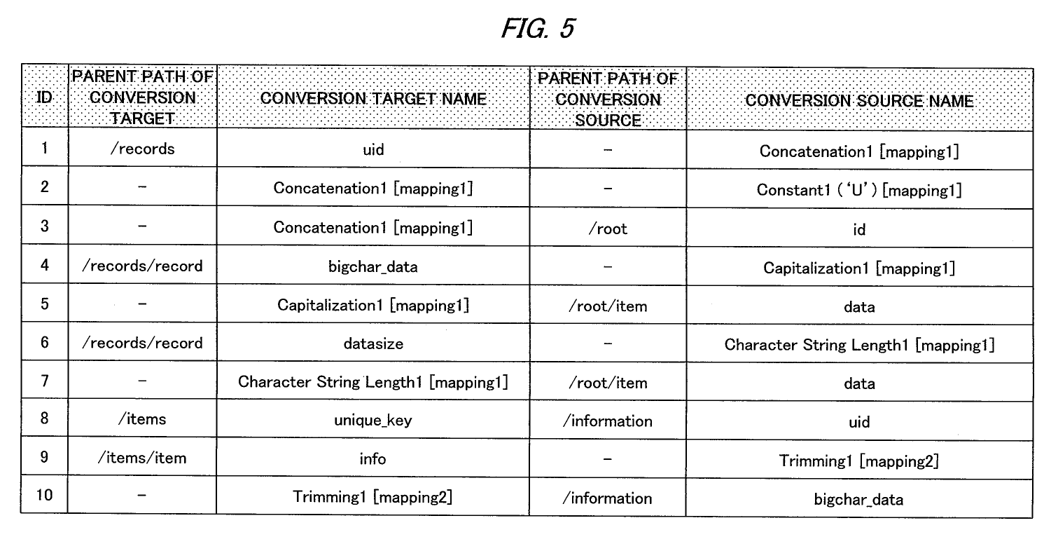

FIG. 5 is a diagram illustrating a data configuration and examples of data of the mapping information storage table 121. When mapping information is extracted from the mapping definitions 401 and 402 of FIG. 4A and FIG. 4B according to the above-described procedure by the mapping information extraction means 113, the data having the contents as shown in FIG. 5 is stored in the mapping information storage table 121. For example, from the mapping which reads as [the value of the element “id” of the structured data definition of conversion source 123 is concatenated to the character ‘U’ and is stored in the element “uid” of the structured data definition of conversion target 124] in the mapping definition 401 of FIG. 4A, the mapping information pieces having IDs 1 to 3 of FIG. 5 are extracted.

Next, there will be described a method of automatically performing a new mapping between the structured data definition of conversion source 123 and the structured data definition of conversion target 124 by the mapping information application means 114 with using the data of the mapping information storage table 121 extracted by the mapping information extraction means 113.

The mapping information application means 114 extracts a specific element (S) from the structured data definition of conversion source 123 and a specific element (T) from the structured data definition of conversion target 124, and combines the specific elements with the mapping information stored in the mapping information storage table 121, thereby checking whether or not it is reachable from S to T (or from T to S) and performing automatic mapping.

This mapping is executed by, for example, selecting the [Automatic Mapping] from the menu 250 of the mapping definition editor 200. At this time, for example, a range within which the automatic mapping is desired to be performed may be designated by executing the automatic mapping after prior designation of the parent element of the element for which the automatic mapping is desired to be performed. For example, in the structured data definition of conversion source 123 and the structured data definition of conversion target 124 of the example of FIG. 2, when the automatic mapping is performed upon designation of the element “itemA” and the element “itemB”, the automatic mapping may be executed only for the “dataA” and the “dataB” which are the child elements thereof, and the “dataB_size”.

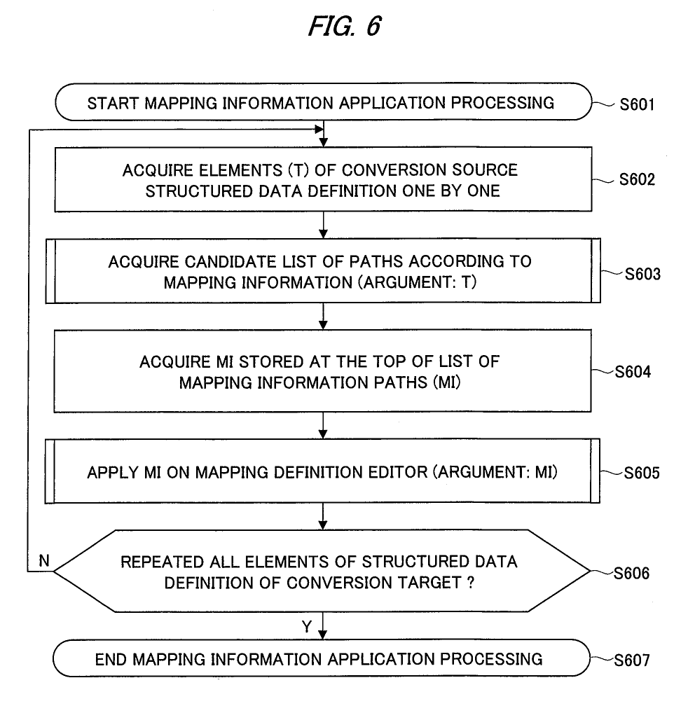

FIG. 6 is an example of a flowchart of the mapping information application processing in the mapping information application means 114. When the processing is started (S601), elements (T) of the structured data definition of conversion target 124 are acquired in order one by one (S602). With this element T taken as an argument, acquisition processing (S603) of a list of candidates of paths by the mapping information is performed, thereby searching the mapping information storage table 121 and acquiring a list of the paths (MI) by the mapping information toward any one of the elements of the structured data definition of conversion source 123 which is reachable from the element T. The detail of the processing of the step S603 will be described later.

At the step S603, since the paths (MI) by the acquired mapping information are stored in a list in the descending order of certainty and returned, the MI stored at the top of the list is acquired (S604). Next, by using the acquired MI, the MI is applied on the mapping definition editor 200 (S605). The detail of the processing of the step S605 will be described later.

Next, whether or not the processing has been repeated for all the elements of the structured data definition of conversion target 124 is checked (S606), and when not repeated, the processing returns to the step S602, and the same processing is executed for the next elements of the structured data definition of conversion target 124. At the step S606, when the processing is repeated for all the elements of the structured data definition of conversion target 124, the processing is terminated (S607).

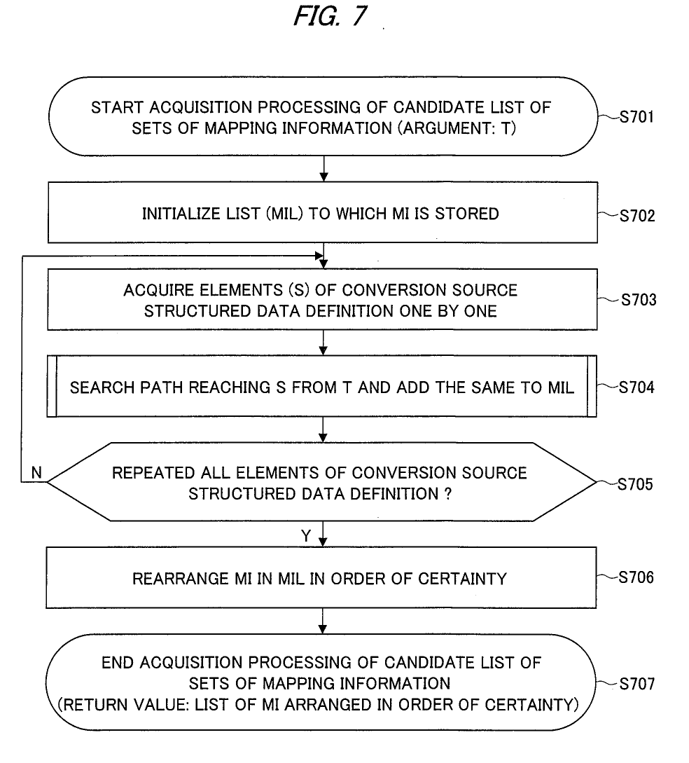

FIG. 7 is an example of a flowchart of the acquisition processing (S603) of a list of candidates of the paths by the mapping information in FIG. 6. When the processing is started (S701), an element (T) of the conversion target is acquired as an argument. First, a list (MIL) to store the paths (MI) by the mapping information are initialized (S702). In this MIL, the list of IDs of the mapping information which are paths to be acquired as the result of the processing described later and information necessary for determining the certainty of acquired paths are stored.

Next, the elements (S) of the structured data definition of conversion source 123 are acquired in order one by one (S703). Next, a path reaching S from T is retrieved and added to the MIL together with the information necessary for determining the certainty of acquired paths (S704). The processing of the step S704 will be described later. Next, whether or not the processing is repeated for all elements of the structured data definition of conversion source 123 is checked (S705), and when not repeated, the processing returns to the step S703, and the processing is repeated for the next element (S) of the structured data definition of conversion source 123. When the processing is repeated for all the elements of the structured data definition of conversion source 123, the MIs from the MIL are rearranged in order of certainty (S706), and then the processing is terminated (S707). The processing of the step S706 will be described later.

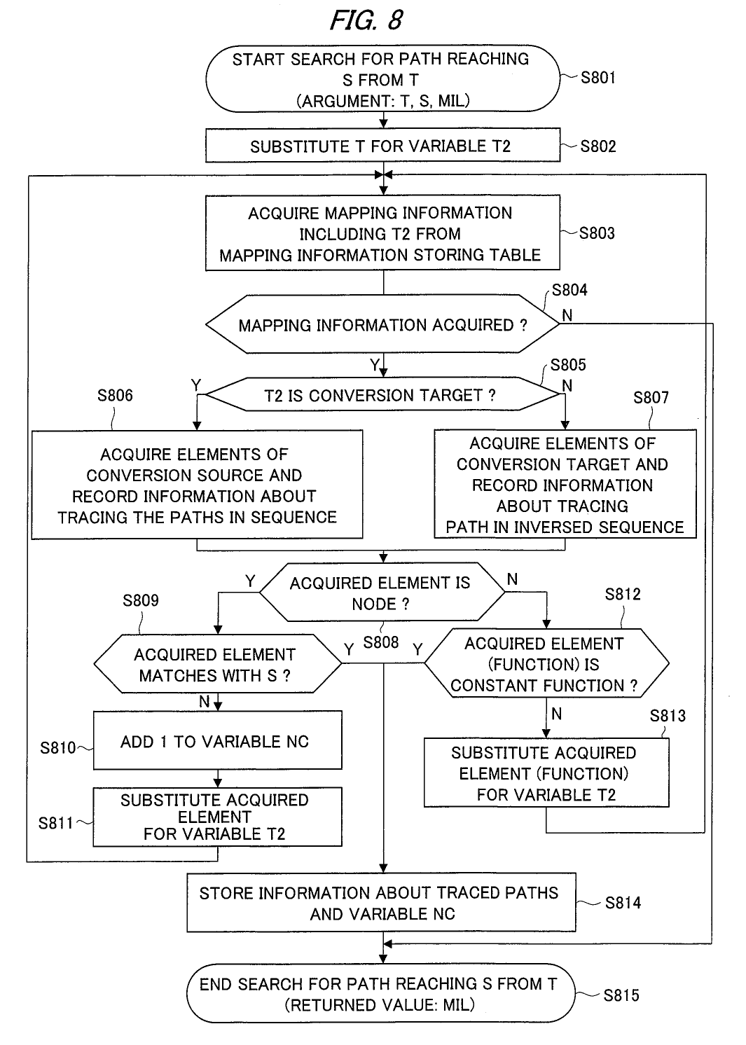

FIG. 8 is an example of a flowchart of the processing (S704) for searching a path reaching S from T in FIG. 7. When the processing is started (S801), first, T is substituted for a variable T2 (S802). Next, the mapping information containing T2 is acquired from the mapping information storage table 121 (S803). Next, whether or not the mapping information has been acquired is checked (S804), and when not acquired, it is determined that the path reaching S from T is not found, and then the processing is terminated (S815). When the mapping information has been acquired, whether or not T2 has become the conversion target in the acquired mapping information is checked (S805). Note that, when a plurality of pieces of the mapping information are acquired, the path is branched off for each of the mapping information, and thus the processings subsequent to the step S805 are performed for each of the mapping information to search the path.

At the step S805, when T2 becomes the conversion target in the acquired mapping information, the element of its conversion source is acquired, and the information to the effect that the mapping information was traced in a forward direction is kept on record (S806). When T2 becomes the conversion source in the acquired mapping information, an element of its conversion target is acquired, and the information to the effect that the mapping information has been traced in a reverse direction is kept on record (S807).

Next, whether or not the acquired element is a node is checked (S808). When it is a node, whether or not the acquired element conforms to S is checked (S809). When it is conformed to S, the information on the traced path (ID of the mapping information and the information in the direction tracing the mapping information) and a variable NC are stored in the list (MIL) (S814), and then the processing is terminated (S815). Here, the variable NC is a variable for counting the number of times the node is passed through in the path reaching S from T, and the variable NC is initialized to 0 when a path is newly searched from T.

At the step S809, when the acquired element does not conform to S, the variable NC is added with 1 (S810), and the acquired element is newly substituted for the variable T2 (S811), and the processing returns to the step S803 to acquire the mapping information containing T2 from the mapping information storage table 121, and then whether or not the corresponding element conforms to S is similarly checked.

At the step S808, when the acquired element is not a node, i.e., it is a function, whether or not the acquired function is a constant function such as a character string constant (for example, “Constant 1 (‘U’)” in the mapping definition 401 of FIG. 4) is checked (S812). When it is a constant function, the information on the traced path and the variable NC are stored in the list (MIL) (S814), and then the processing is terminated (S815). When it is not a constant function, the acquired function is substituted for the variable T2 (S813), and the processing returns to the step S803 to acquire the mapping information containing T2 from the mapping information storage table 121, and then whether or not the corresponding element conforms to S is similarly checked. By the above-described procedure, the path reaching S from T can be determined.

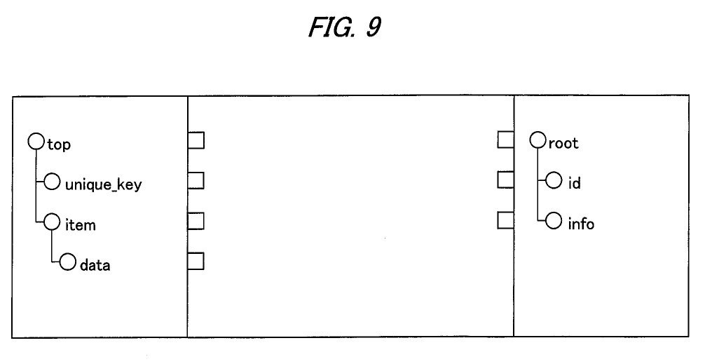

Hereinafter, a method of determining the path reaching S from T will be described with a concrete example. The mapping information storage table 121 is assumed to store the mapping information shown in FIG. 5. At this time, for example, when the automatic mapping is performed between the structured data definition of conversion source 123 and the structured data definition of conversion target 124 such as those shown in FIG. 9, by way of example, descriptions will be made with taking the element “id” of the structured data definition of conversion target 124 and the element “unique_key” of the structured data definition of conversion source 123 as T and S in the flowcharts of FIG. 7 and FIG. 8, respectively.

First, the mapping information containing a node “id” in the element is acquired from the mapping information storage table 121 (S802, S803, and S804). In the mapping information storage table 121 of FIG. 5, since the mapping information containing the node “id” is only the mapping information whose ID is 3, this mapping information is acquired. Next, the element corresponding to the node “id” is acquired for the acquired mapping information (S805 and S807). The mapping information whose ID is 3 corresponds to a function “Concatenation 1 [mapping 1]”.

Since the acquired “Concatenation 1 [mapping 1]” is not the node, but the function (S808), that is, it is not the constant function (S812), the mapping information containing the acquired function “Concatenation 1 [mapping 1]” is further acquired from the mapping information storage table 121 (S813, S803, and S804). Although the mapping information pieces whose IDs are 1, 2, and 3 correspond to this mapping information, when the mapping information that has been already traced is traced, the processing gets to be looped. Hence, with the targeted mapping information pieces whose untraced IDs are 1 and 2, the following processing is performed.

First, the node “uid” which is the element corresponding to the function “Concatenation 1 [mapping 1]” is acquired for the mapping information whose ID is 1 (S805 and S807). Since the acquired “uid” is not a function, but a node (S808), whether or not the acquired node “uid” conforms to S (“unique_key”) is checked (S809). Since it does not conform to S here, the variable NC is added with 1 in order to count the number of times the node is passed through (S810), and the mapping information, which contains the node “uid” and is not yet traced, is acquired from the mapping information storage table 121 (S811, S803, and S804). The mapping information whose ID is 8 corresponds to this mapping information, and acquires the node “unique_key” corresponding to the node “uid” (S805 and S807). This is a node and conforms to S (“unique_key”), and therefore, the search is terminated (S808 and S809).

Next, a function “Constant 1 (‘U’) [mapping 1]” which is the element corresponding to the function “Concatenation 1 [mapping 1]” is acquired for the mapping information whose ID is 2 (S805 and S807). In the case of such a function of constant, since no further existence of the connection source is available, the search is terminated here (S812).

From the above processings, when the paths by the mapping information for reaching S from T are indicated by IDs, the paths such as [3, 1, 8, 2] are obtained. Further, at the time of searching the path toward S which is the conversion source from T which is the conversion target, since there is a case where the mapping information is reversely traced from the conversion source toward the conversion target, at the steps S806 and S807, the information indicating which direction out of the forward direction and the reverse direction the mapping information has been traced is kept on record. Based on this information, a list of flags indicating the direction to which the mapping information is traced is created. For example, when assuming that the case where the mapping information is traced in the forward direction is shown as “0” and the case where the mapping information is traced in the reverse direction is shown as “1”, in the above example, since all the paths have been reversely traced for each mapping information, a list such as [1, 1, 1, 1] is obtained.

In addition to T, S, and a list of IDs of the mapping information, as information pieces necessary for determining the certainty, a list of flags indicating a direction to which the mapping information has been traced and the value of the variable NC are added to the MIL as a set of paths (MI) by mapping information (S814). This search method of the paths is only one example, and the paths may be searched by another method. In the present embodiment, while the search has been performed toward the structured data definition of conversion source 123 from the structured data definition of conversion target 124, the search may be performed toward the structured data definition of conversion target 124 from the structured data definition of conversion source 123.

Next, at the step S706 of FIG. 7, the processing for rearranging MIs in order of certainty from the list (MIL) of the paths (MI) by the mapping information for reaching S from T will be described. Here, the list of MIL is evaluated to analogize the best path, and rearrangement for displaying the path on the mapping definition editor 200 is performed.

For example, each MI in the MIL is evaluated by the criteria of determination as shown below to calculate its certainty, and the MIs are rearranged in order of certainty. The calculation of the certainty is performed such that prescribed scores are added and subtracted according to whether or not each MI conforms to each of the following criteria, and it is considered that the certainty is calculated as its total score.

(1) If any of elements of an ancestor of an element (T) of the structured data definition of conversion target 124 appears in a parent path of the mapping information containing T of MI, the score is added.

(2) If any of elements of an ancestor of an element (S) of the structured data definition of conversion source 123 appears in a parent path of the mapping information containing S of MI, the score is added.

(3) If a conversion source of T in MI is a constant function only, the score is subtracted.

(4) The score is subtracted according to the number of times the mapping information is reversely traced in the paths of MI.

(5) The score is subtracted according to the number of times the node is passed through in the paths of MI.

As a concrete example, for example, let's assume that the element (S) of the mapping target of the structured data definition of conversion source 123 is “unique_key”, and its parent path is “/top”, and further the element (T) of the mapping target of the structured data definition of conversion target 124 is “id”, and its parent path is “/root”. At this time, for example, when the parent path of the mapping information containing T in MI is “/root”, since “root” which is an element of the ancestor of T appears, this MI falls under the condition (1), and thus the score is added. Further, for example, when the parent path of the mapping information containing T in MI is “/info”, this MI does not fall under the condition (1).

Since S of the condition (2) is similarly determined, when both of T and S fall under the conditions (1) and (2) at the same time, respectively, the score becomes larger than that of the case where only either one of T and S falls under the condition (1) or the condition (2), and thus the certainty of the corresponding MI is increased.

Further, in the MI, for example, when the element of the termination of the conversion source of T is a constant function only such as a character string constant, since it falls under the condition (3) and the score is subtracted, the certainty is lowered. Further, since the score is subtracted based on the condition (4) out of the information necessary for determining the certainty according to the number of times the mapping information in the list of flags that indicates the direction to which the mapping information is traced is inversely traced, the certainty is lowered as the number of times the mapping information is inversely traced is increased. For example, similarly to the example as described above, when the list of the flags that indicates the direction to which the mapping information is traced is [1, 1, 1, 1], the score equivalent to four times is subtracted. Further, out of the information necessary for determining the certainty, since the score is subtracted based on the condition (5) according to the value of the variable NC, the certainty is lowered as the number of times the node is passed through is increased.

Note that, in the above-described example, the value of the score to be added and subtracted can be arbitrarily decided. Further, the score may be calculated by other calculation methods instead of addition and subtraction. Further, the conditions (1) to (5) are meant for an example for calculating the certainty by using: the information about whether or not an element of an ancestor of a target element of the structured data definition of conversion source 123 or the structured data definition of conversion target 124 conforms to an element contained in a parent path of an element of termination of a path by mapping information; the information on the number of times mapping information is reversely traced in a path by mapping information; and the information on the number of times a node (element other than the function) is passed through in a path by mapping information, and the certainty may be calculated by not using all of these pieces of information or by using other information and condition.

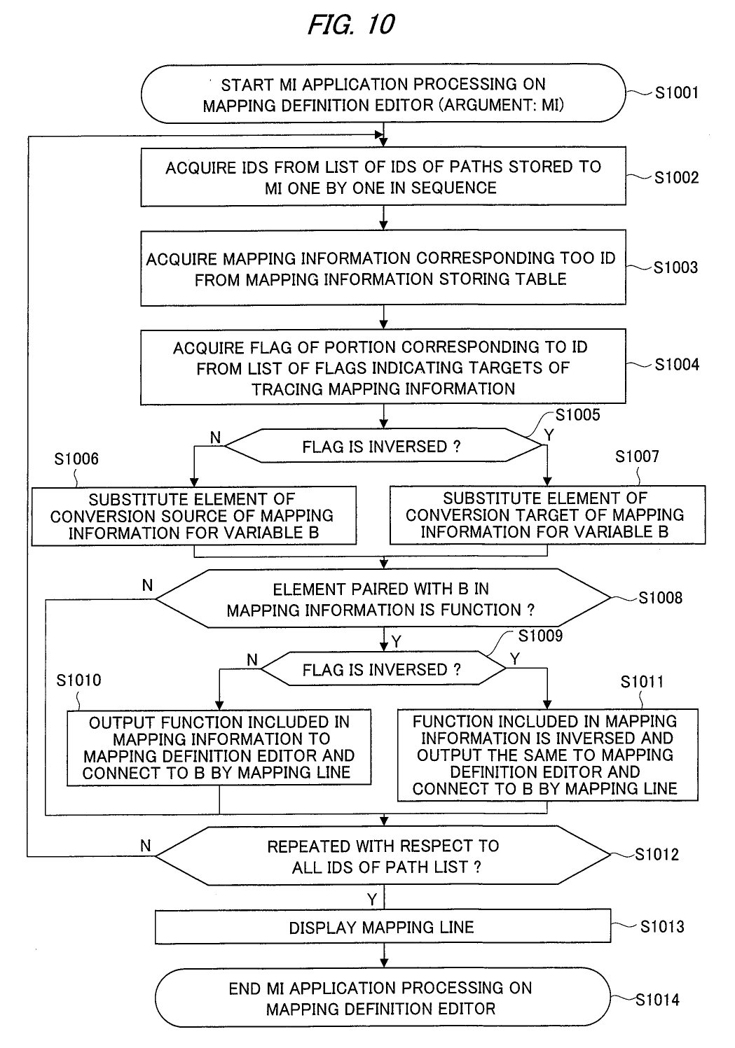

Next, the processing (S605) for applying the MI on the mapping definition editor 200 in FIG. 6 will be described. FIG. 10 is an example of a flowchart of the processing (S605) for applying the MI on the mapping definition editor 200 in FIG. 6. When the processing is started (S1001), IDs are acquired in order one by one from the list of IDs of the paths of the mapping information stored in the MI passed as an argument (S1002). Next, the mapping information pieces corresponding to the acquired IDs is acquired from the mapping information storage table 121 (S1003).

Next, from the list of flags indicating the direction to which the mapping information is traced, the flags of portions corresponding to the acquired IDs are acquired (S1004). For example, when the ID is the second one of the list of paths, the second flag of the list of flags is acquired. Next, whether or not the acquired flag indicates that the tracing is in the reverse direction is checked (S1005), and when not indicating, that is, indicating that the tracing is in the forward direction, the element of the conversion source of the mapping information is substituted for a variable B (S1006). When the flag indicates the tracing in the reverse direction, the element of the conversion target of the mapping information is substituted for the variable B (S1007).

Next, whether or not the element making a pair with B in the mapping information is a function is checked (S1008). When it is a function, whether or not the flag acquired at the step S1004 indicates the tracing in the inverse direction is checked (S1009). When not indicating the inverse direction, that is, indicating the tracing in the forward direction, the function contained in the mapping information is outputted on the mapping definition editor 200, and connected to the element corresponding to the variable B by a mapping line (S1010). When the flag indicates the tracing in the inverse direction, the function contained in the mapping information is made into an inverse function and outputted on the mapping definition editor 200, and then connected to the element corresponding to the variable B by a mapping line (S1011). The inverse function will be described later.

Next, whether or not the processing is repeated for all the IDs of the paths stored in the MI is checked (S1012), and when the processing is not repeated for all the IDs, the processing returns to the step S1002, and the processing continues by acquiring the next IDs from the ID list of the paths stored in the MI. When the processing is repeated for all the IDs, the mapping line that connects the target element of the structured data definition of conversion source 123, the target element of the structured data definition of conversion target 124 or the function (inverse function) on the path is displayed (S1013), and then the processing is terminated (S1014). When the mapping line is displayed on the mapping definition editor 200, a color and the like of the mapping line in the processing may be changed and displayed in order to distinguish it from the mapping line that has been already stretched by the user.

In the mapping information application processing of FIG. 6, by executing the processings described for the steps S602 to S605 for all the elements of the elements of the structured data definition of conversion target 124, the mapping is automatically created. The automatically created mapping can be changed by the mapping definition edit means 112 by using the mapping definition editor 200. The mapping finally completed is stored as a mapping definition 125 and is built into the system, and after that, it is used for converting structured data according to the structured data definition of conversion source 123 into structured data according to the structured data definition of conversion target 124.

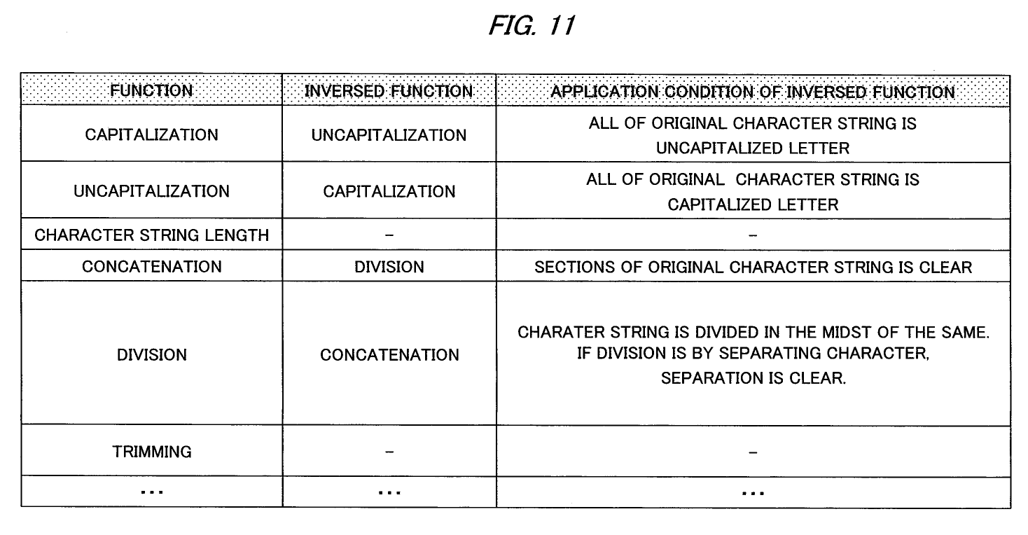

Here, at the step S1011 of FIG. 10, a method for determining the inverse function of the function contained in the mapping information will be described. As one example of the method for determining the inverse function, a method is conceivable where an inverse function management table 122 is held, and with the function whose inverse function is desired to be determined as a key, the inverse function is determined with reference to the inverse function management table 122. FIG. 11 is a view showing an example of the data structure and the data of the inverse function management table 122. For example, when an inverse function of the function of “Capitalization” is determined from the inverse function management table 122 of FIG. 11, the function of “Uncapitalization” can be acquired.

However, upon applying the inverse function to the mapping information, there exists an application condition. For example, the condition for applying the “Uncapitalization” to the function of the “Capitalization” as the inverse function is that the whole original character string to which the function of the “Capitalization” is applied is in lowercase letters.

When the inverse function is displayed on the mapping definition editor 200, this condition is displayed being contained in the inverse function to be displayable. For example, a method is conceivable in which the color of the inverse function is changed to a striking color, and when a mouse pointer is put on the inverse function, this condition is displayed by pop-up, thereby notifying the user of the appearance of the inverse function in the mapping information with the condition.

Note that, there are some cases where the inverse function does not exist among the functions. For example, since the substance of the original character string cannot be determined from the length of the character string determined by a function of “Character String Length”, the inverse function does not exist in the function of “Character String Length”. In such a case, for example, a mark and the like indicating that an inverse function does not exist are displayed on the mapping definition editor 200. Thereby, the user can find out that, though the function exists in the mapping information, its inverse function does not exist, and also that some kinds of corrections are required.

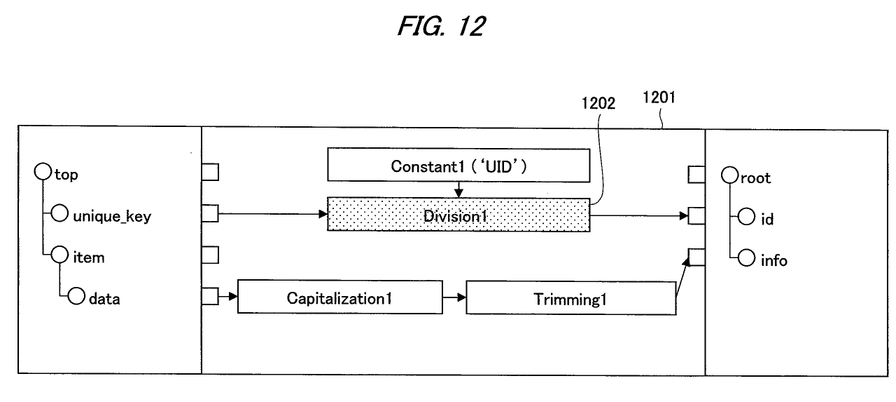

According to the above-described procedures, when the automatic mapping is actually performed for the examples of the structured data definition of conversion source 123 and the structured data definition of conversion target 124 illustrated in FIG. 9 by using the example of the mapping information storage table 121 illustrated in FIG. 5 and the example of the inverse function management table 122 illustrated in FIG. 11, a mapping definition 1201 shown in FIG. 12 can be acquired.

A function 1202 (“Division 1”) in FIG. 12 is indicated by, for example, a colored box, and displays that the function 1202 is an inverse function, and also that a condition exists when this inverse function is applied. By putting the mouse pointer on the box of the function 1202 and double-clicking, the content of the condition can be displayed to the user.

As described above, according to the mapping automation system of the present embodiment, by combining the existing mapping definitions 125 and automatically performing the inverse conversion of the existing mapping definitions 125, the existing mapping definitions 125 can be effectively reused, and even when there does not exist one whose structure of the whole structured data conform to each other in the existing mapping definitions 125, it is possible to automatically perform the mapping for a plurality of elements contained in the structured data definition of conversion source 123 or the structured data definition of conversion target 124. Further, since it is unnecessary to perform the preparation of a thesaurus and the processing of the mapping definition and the like in advance, the operational load of the user of the advance preparation can be reduced, thereby reducing development cost at the time of system construction.

### Second Embodiment

While a description has been made on the method for executing the automatic mapping for the plurality of elements contained in the structured data definition of conversion source 123 or the structured data definition of conversion target 124 in the above-described first embodiment, a method for automating mapping for a specific element contained in the structured data definition of conversion source 123 or the structured data definition of conversion target 124 in the mapping definition creating system of the first embodiment will be described in a second embodiment of the present invention.

First, in the mapping definition editor 200, a target element of the structured data definition of conversion target 124 is selected, and the execution of the automatic mapping for the target element is started by, for example, pressing a specific key of a keyboard or the operating by a mouse.

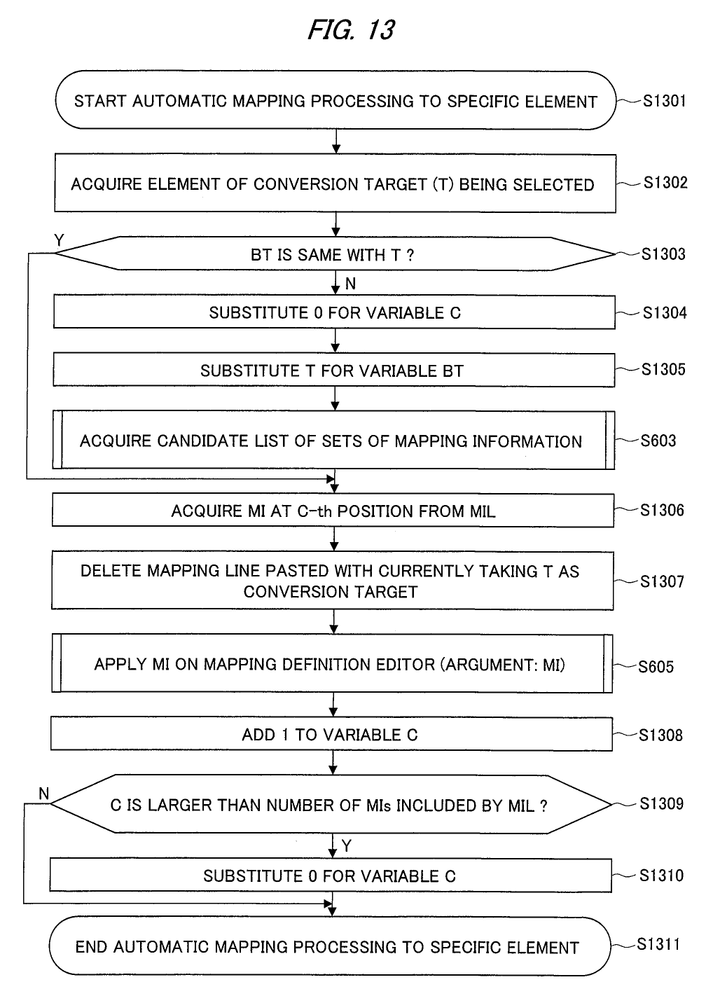

FIG. 13 is an example of a flowchart of the automatic mapping processing for a specific element. Variables BT and C used here are initialized beforehand at the time of starting the present system, and after that, the initialization is not performed every time the automatic mapping processing is performed for the specific element. When the processing is started (S1301), first, the selected element (T) of the structured data definition of conversion target 124 is acquired (S1302).

Here, an element of the structured data definition of conversion target 124 that has been selected when the precious automatic mapping processing has been executed by the processing flow is held in the variable BT, and whether or not the variable BT and the element T are the same is checked (S1303). When they are the same, since a list (MIL) of the mapping information for the element is already acquired by the previous processing, the processing advances to a step S1306. When the variable BT and T are not the same, 0 is substituted for the variable C (S1304), and the variable BT is substituted for T (S1305). After that, with taking T as an argument, a candidate list acquisition processing of the paths by the mapping information is executed, and the MIL storing MIs in order of certainty is acquired. This processing is the same as the step S603 of FIG. 6 (steps S701 to S707 of FIG. 7) of the first embodiment.

Next, a C-th MI corresponding to a value of the variable C is acquired from the acquired MIL (S1306). Next, the mapping line currently being stretched with T as the conversion target is deleted (S1307). Next, with the acquired MI as an argument, the processing applying the MI on the mapping definition editor 200 is executed, and the MI whose certainty is the C-th is applied on the mapping definition editor 200. This processing is the same as the step S605 of FIG. 6 (steps S1001 to S1014 of FIG. 10) of the first embodiment.

Next, the variable C is added with 1 (S1308), and whether or not the value of the variable C is higher than the number of MIs contained in the MIL is checked (S1309). When the value of the variable C is larger, 0 is substituted for the variable C (S1310), and when not larger, the processing is terminated as it is (S1311).

By the above-described processings, the mapping is automatically performed in descending order of certainty on the mapping definition editor 200 every time the specific key is pressed and the mouse is operated in a state where the specific element of the structured data definition of conversion target 124 is selected. That is, the display of the mapping line is switched over sequentially. When the mapping line is displayed up to the candidate lowest in the certainty stored at the bottom of the MIL, it goes back to the candidate highest in the certainty stored in the top of the MIL, and then the mapping is displayed again. Thereby, the user can select the most appropriate candidate from the automatically created list of MIs.

Note that, though descriptions have been made on the method for automatically performing the mapping in a state where an specific element of the structured data definition of conversion target 124 is selected in the present embodiment, it is also possible to perform the selection of a candidate similarly by designating not an element of the structured data definition of conversion target 124, but an element and a function of the structured data definition of conversion source 123.

Further, though the present embodiment has used, as a method of selecting the most appropriate candidate from the list of MIs automatically created, a user interface in which the display of the mapping line and the function is switched over sequentially to those of the next candidate on the mapping definition editor 200 by pressing a specific keys and an operation and the like of a mouse, it is not limited to this.

For example, a view of the lists is presented in various ways such as: displaying a view of MIs contained in the list by displaying on a pop-up menu as a list by texts according to a pressing of a specific key and an operation and the like of a mouse; displaying all the mappings by the mapping lines distinguishable from one another; and changing the color of the display of the element only of the structured data definition of conversion source 123 contained in the MI of the candidate when the mouse pointer is put on the corresponding element, so that the mapping line for the corresponding MI is displayed. The user interface can be prepared such that a candidate is selected from the view of lists to perform the mapping.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, in the above-described embodiments, though the mapping definition creation system is realized by a set of the computer system as shown in FIG. 1, the system is not limited to this, but can be configured such that the memory unit 120 exists in the server as a system of client/server type or a part of the control unit 110 and the memory unit 120 exist in the server. Further, the system can be configured such that the user accesses to the server through the Internet and the like to use the present system as a service by an ASP (Application Service Provider) and the like.

The present invention can be used for a mapping definition creation system and a mapping definition creation program for converting data from a specific format to another format by the program operating on a computer.

What is claimed is:

1. A mapping definition creation system for creating a mapping definition which is a conversion rule at the time of converting structured data according to a structured data definition of a conversion source into a format of a structured data definition of a conversion target, the mapping definition creation system comprising:
a mapping information storage table for storing mapping information which is a pair of an element of the conversion source and an element of the conversion target extracted from an existing mapping definition;
mapping information extraction means for extracting the mapping information from the existing mapping definition and storing the same in the mapping information storage table; and
mapping information application means for: acquiring the mapping information necessary for converting the element of the structured data definition of the conversion source into the corresponding element of the structured data definition of the conversion target from the mapping information stored in the mapping information storage table with respect to each element of the structured data definition of the conversion source and the structured data definition of the conversion target to be converted; and creating the mapping definition for the structured data definition of the conversion source and the structured data definition of the conversion target by using the acquired mapping information.

2. The mapping definition creation system according to claim 1, wherein
the mapping information application means acquires the mapping information as a path by the mapping information combined by concatenating a plurality of pieces of the mapping information at the time of acquiring the mapping information necessary for converting the element of the structured data definition of the conversion source into the corresponding element of the structured data definition of the conversion target from the mapping information stored in the mapping information storage table.

3. The mapping definition creation system according to claim 2, wherein,
at the time of creating the mapping definition for the structured data definition of the conversion source and the structured data definition of the conversion target by using the path by the acquired mapping information,
when there is mapping information contained, in the acquired path by the mapping information which inversely traces from an element of the conversion target to an element of the conversion source and also has a function which is a predetermined conversion function,
the mapping information application means acquires an inverse function capable of restoring an execution result of the function for creating the mapping definition by using the inverse function.

4. The mapping definition creation system according to claim 3, comprising an inverse function management table for storing the function, the inverse function corresponding to the function, and a condition at the time of applying the inverse function, wherein
the mapping information application means acquires, at the time of acquiring the inverse function for the function, the inverse function corresponding to the function, and the condition at the time of applying the inverse function from the inverse function management table.

5. The mapping definition creation system according to claim 4, comprising mapping definition edit means for providing a user interface for displaying, creating, and editing the structured data definition of the conversion source, the structured data definition of the conversion target, and the mapping definition for these definitions, wherein,
at the time of displaying the mapping definition for the structured data definition of the conversion source and the structured data definition of the conversion target on the user interface,
the mapping definition edit means displays a message indicating that the function to be displayed is the inverse function, and further displays so that the condition at the time of applying the inverse function is referable when the inverse function exists in the path by the mapping information.

6. The mapping definition creation system according to claim 2, wherein,
at the time of acquiring the paths by the mapping information necessary for converting the element of the structured data definition of the conversion source to the corresponding element of the structured data definition of the conversion target from the mapping information stored in the mapping information storage table,
when a plurality of paths by the mapping information to respective elements of the structured data definition of the conversion target for a specific element of the structured data definition of the conversion source are acquired or a plurality of paths by the mapping information to respective elements of the structured data definition of the conversion source for a specific element of the structured data definition of the conversion target are acquired,
the mapping information application means selects a path to be applied from among the acquired plurality of paths by the mapping information based on more than one information pieces from: information on whether or not an element of an ancestor of a target element of the structured data definition of the conversion source or the structured data definition of the conversion target conforms to an element contained in a parent path of an element of a termination of the path by the mapping information; information on a number of times the mapping information is inversely traced in the path by the mapping information; and information on a number of times the element other than the function is passed through in the path by the mapping information.

7. The mapping definition creation system according to claim 6, wherein
the mapping definition edit means, at the time of displaying the mapping definitions for the structured data definition of the conversion source and the structured data definition of the conversion target on a user interface, sequentially switches over each of the paths by the plurality of pieces of mapping information acquired by the mapping information application means according to instruction from a user to display the mapping definitions on the user interface, so that the path by the mapping information to be applied is made selectable by the user.

8. A mapping definition creation program allowing a computer to operate as a mapping definition creation system for creating a mapping definition which is a conversion rule at the time of converting structured data according to a structured data definition of a conversion source into a format of a structured data definition of a conversion target, the mapping definition creation program executing:
a mapping information extraction processing for extracting mapping information which is a set of an element of conversion source and an element of conversion target from the existing mapping definition and storing it in a mapping information storage table; and
a mapping information application processing for: acquiring the mapping information necessary for converting the element of the structured data definition of the conversion source into the element corresponding to the structured data definition of the conversion target from the mapping information stored in the mapping information storage table with respect to each element of the structured data definition of the conversion source and the structured data definition of the conversion target to be converted; and creating the mapping definition for the structured data definition of the conversion source and the structured data definition of the conversion target by using the acquired mapping information.

9. The mapping definition creation program according to claim 8, wherein
the mapping information application processing, at the time of acquiring the mapping information necessary for converting the element of the structured data definition of the conversion source into the corresponding element of the structured data definition of the conversion target from the mapping information stored in the mapping information storage table, acquires the mapping information as a path by the mapping information combined by concatenating a plurality of pieces of the mapping information.

10. The mapping definition creation program according to claim 9, wherein
at the time of creating the mapping definition for the structured data definition of the conversion source and the structured data definition of the conversion target by using the path by the acquired mapping information,
when there is mapping information contained in the acquired path by the mapping information which inversely traces from an element of the conversion target to an element of the conversion source and also has a function which is a predetermined conversion function,
the mapping information application processing acquires an inverse function capable of restoring an execution result of the function for creating the mapping definition by using the inverse function.

11. The mapping definition creation program according to claim 10, wherein
the mapping information application processing, at the time of acquiring the inverse function for the function, acquires the inverse function corresponding to the function and a condition at the time of applying the inverse function from the inverse function management table storing the function, the inverse function corresponding to the function, and the condition at the time of applying the inverse function.

12. The mapping definition creation program according to claim 11, executing a mapping definition editing processing for providing a user interface for displaying, creating, and editing the mapping definitions for the structured data definition of the conversion source and the structured data definition of the conversion target, and the mapping definition for these definitions, wherein
the mapping definition editing processing, at the time of displaying the mapping definition for the structured data definition of the conversion source and the structured data definition of the conversion target on the user interface, displays a message to the effect that the function to be displayed is the inverse function, and further displays so that the condition at the time of applying the inverse function is referable when the inverse function exists in the path by the mapping information.

13. The mapping definition creation program according to claim 9, wherein,
at the time of acquiring the paths by the mapping information necessary for converting the element of the structured data definition of the conversion source to the corresponding element of the structured data definition of the conversion target from the mapping information stored in the mapping information storage table,
when a plurality of paths by the mapping information to respective elements of the structured data definition of the conversion target for a specific element of the structured data definition of the conversion source are acquired or a plurality of paths by the mapping information to respective elements of the structured data definition of the conversion source for a specific element of the structured data definition of the conversion target are acquired,
the mapping information application processing selects a path to be applied from among an acquired plurality of paths by the mapping information based on more than one information pieces from: information on whether or not an element of an ancestor of a target element of the structured data definition of the conversion source or the structured data definition of the conversion target conforms to an element contained in a parent path of an element of a termination of the path by the mapping information; information on a number of times the mapping information is inversely traced in the path by the mapping information; and information on a number of times the element other than the function is passed through in the path by the mapping information.

14. The mapping definition creation program according to claim 13, wherein
the mapping definition editing processing, at the time of displaying the mapping definitions for the structured data definition of the conversion source and the structured data definition of the conversion target on a user interface, sequentially switches over each of the paths by the plurality of pieces of mapping information acquired by the mapping information application means according to instruction from a user to display the mapping definitions on the user interface, so that the path by the mapping information to be applied is made selectable by the user.
